(19) United States
(12) Patent Application Publication
(10) Pub. No.: US 2010/0289755 A1
(43) Pub. Date: Nov. 18, 2010

(54) Touch-Sensing Liquid Crystal Display

(75) Inventors: Xiuling Zhu, New Territories (HK); Kwan Wah Ng, Kowloon Bay (HK); Yaojun Feng, Shenzhen (CN); Min Chen, Kowloon Bay (HK)

Correspondence Address: BERKELEY LAW & TECHNOLOGY GROUP, LLP, 17933 NW Evergreen Parkway, Suite 250, BEAVERTON, OR, 97006, US

(73) Assignee: Honh Kong Applied Science and Technology Research Institute Co., Ltd., New Territories (HK)

(21) Appl. No.: 12/467,004

(22) Filed: May 15, 2009

(51) Int. Cl. G06F 3/041

(52) U.S. Cl. 345/173

(57) ABSTRACT

Disclosed are systems, methods and techniques to integrate touch-sensing functionality with a liquid crystal display (LCD) panel. In a particular implementation, light sensing detectors are disposed on a backlight panel to detect changes in light incident on the backlight panel in response to a physical touching on a surface of an LCD panel. A location of the physical touching may then be estimated based upon signals received from the light sensing detectors.

### BACKGROUND

1. Field

This disclosure is related to a liquid crystal display with touch-sensing capability.

2. Information

Liquid-crystal displays (LCDs) have been implemented in a variety of display applications, such as computer displays, personal display assistants (PDAs), kiosks, cell phone displays, etc. Touch sensing displays may allow users to select particular regions on a screen using a variety of input devices, simply by touching that area of the display or placing and object such as a finger, stylus, or pen, etc. touching or in close proximity to that region.

One approach to integrate an LCD display with a touch-sensing function includes integrating photo sensor arrays into the thin film transistors (TFT) backplane of an LCD panel. Such photo sensor arrays may sense one or more objects such as a finger on or above the display screen by detecting a shadow of ambient light cast by an object or reflected light from an object, which is illuminated by a controlled light source. This kind of photo sensor array may have different structures and comprise different materials from an LCD TFT backplane. Then, integrating these sensor arrays into TFT backplane typically adds fabrication process steps. This may result in increased manufacturing expense and complexity of the display, as well as reduce the manufacturing yield of the display. Furthermore, such a photo sensor array may reduce an aperture ratio of pixels in an LCD panel, affecting the performance of the display. So far, such approaches are limited for small size LCD display because of fabrication difficulties.

Therefore, it is desired to achieve an LCD display with touch-sensing capability which does not significantly increase the cost and affect the performance of the display.

### BRIEF DESCRIPTION OF THE FIGURES

Non-limiting and non-exhaustive features will be described with reference to the following figures, wherein like reference numerals refer to like parts throughout the various figures, in which:

FIG. 1 is a cross-sectional diagram of a touch-sensing LCD according to an embodiment;

FIG. 2 is a schematic diagram of a touch-sensing LCD system according to an embodiment;

FIG. 3 is a cross-sectional diagram of a touch-sensing LCD including a pressure transfer film according to an embodiment;

FIG. 4 is a cross-sectional diagram of an LCD panel according to an embodiment;

FIGS. 5A and 5B are plan views of alternative embodiments of a backlight unit having a panel with touch-sensing light detectors and visible light sources disposed thereon;

FIG. 6 is a flow diagram illustrating processing of signals from touch-sensing light detectors to estimate a location of a physical touching on a surface of an LCD panel according to an embodiment;

FIG. 7 illustrated one particular technique for obtaining an estimate of a physical touching on an LCD panel using a lookup table according to an embodiment; and

FIG. 8 is a flow diagram illustrating some aspects of providing an estimate of a location of a touching on a surface of an LCD panel according to an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

To provide an LCD display with touch-sensing capabilities and with out significantly increasing the cost and complexity of the LCD display, according to particular embodiments, a backlight unit of an LCD display may include localized light detectors or sensors which are adapted to respond to changes in incident light caused by a physical touching. Signals received from the light detectors may be processed to estimate a location of the physical touching on a surface of an LCD panel. By disposing localized light detectors on a backlight unit, the complexity and expense associated with integrating photo sensor arrays into TFT's of a backplane of an LCD panel may be avoided.

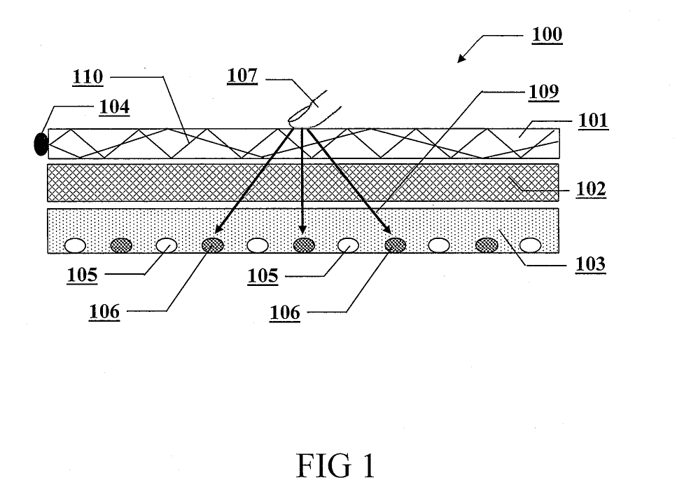

FIG. 1 illustrates a cross-section of an embodiment of a touch-sensing LCD 100, comprising: an optical light-guide 101 with at least one touch-sensing light source 104 positioned at its edge, an LCD panel 102 and a backlight unit 103.

Optical light-guide 101 may comprise a uniform transparent plate, such as acrylic plate or Plexiglas®, having a refractive index larger than 1.0. The thickness of optical light-guide 101 may be in the range of 4.0 mm to 20.0 mm for example. It should be understood, however, that different thicknesses and materials may be used. The touch-sensing light source 104 may emit non-visible light, such as near infrared light with a wavelength range of 750 nm to 1000 nm, into optical light-guide 101 through the edge surface of light-guide 101. It should be understood, however, that light of different wavelength may be used. It is well-known that, total internal reflection may occur in a medium with a refractive index n₁ at a boundary with another medium of lower refractive index n₂ if the incident angle at the boundary larger than a critical angle θ_{c}. Where the critical angle θ_{c} is calculated with Snell's law equation: n₁*sin (θ_{c})=n₂. For example, in this case, if the light-guide 101 is acrylic plate, its refractive index may be about n₁=1.5, and another material is air with a refractive index of about n₂=1.0, then the critical angle may be determined to be about 41.8°. Then at the boundary of light-guide 101 and air, if the light incident angles are larger than 41.8° the light may be totally reflected and trapped within light-guide 101 bouncing between its upper and lower surface. Light trapped within light-guide 101 is shown as touch-sensing light 110. Upon a physical touch from an object such as a finger in contact with a surface of optical light-guide 101, internal refraction may be interrupted as light, otherwise trapped in optical light guide 101, escapes from the light-guide 101 in response to the physical touch. Such escaped light is denoted as 109 in FIG.1.

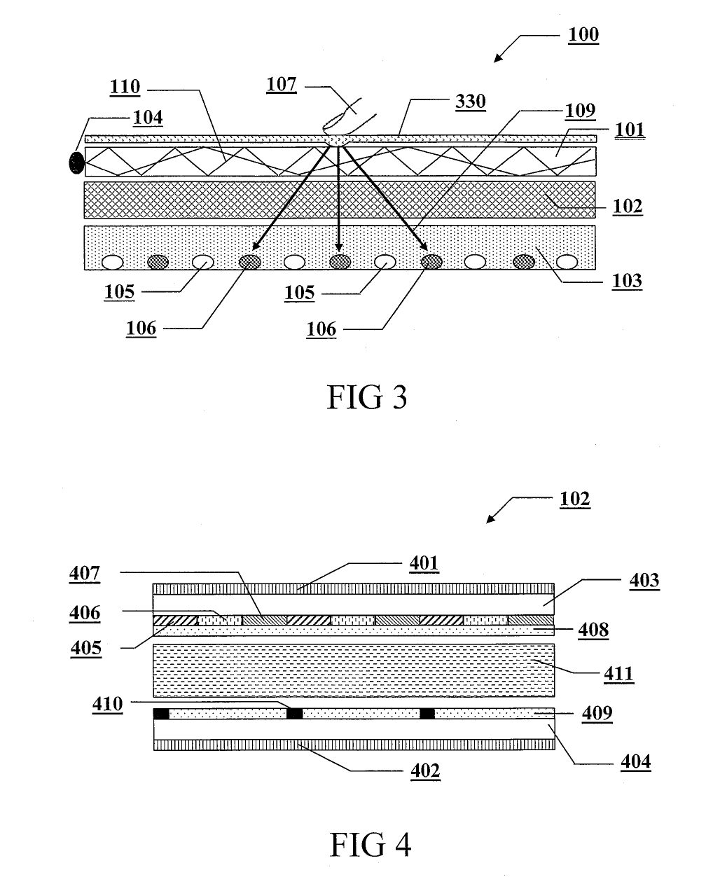

In order to create a more uniform response to different material and size touch objects, a pressure transfer film can be placed above optical light-guide 101. As shown in FIG. 3, pressure transfer film 330 is positioned adjacent to light-guide 101. There is a small air gap between pressure transfer film 330 and the light-guide 101 so that internal reflection may be maintained in the absence of touches on the surface of pressure transfer film 330. In a particular implementation, pressure transfer film 330 may be transparent and flexible. In response to pressure applied by a touch object, a local portion of pressure transfer film 330 being touched may be depressed to contact with the light-guide 101, interrupting internal reflection in light-guide 101 to allow light to escape as discussed above. Here, pressure transfer film 330 may deform in response to touch, thereby contacting with the surface of light-guide 101 and causing total internal reflection of light in light-guide 101 to be interrupted. Consequently, some portion of light 109 may escape out of light-guide from the contact position. In particular, pressure transfer film 330 may comprise thickness in the range of 0.2 mm to 5.0 mm.

According to an embodiment, touch-sensing light sources 104 may comprise infrared light-emitting diodes (LEDs) with peak emission wavelength larger than 850 nm while less than 1000 nm. LEDs with high power emission at these wavelength ranges can be achieved without interference with an image displayed on LCD panel 102. Touch-sensing light sources 104 may be fixed to printed circuit board (PCB, not shown) by soldering and positioned at edges of the light-guide 101 as shown. A touch-sensing light source driving circuit 204 may control emission light intensity of light sources 104 in accordance with signals and/or instruction from touch-sensing LCD control unit 220. In order to efficiently couple emitted light into the light-guide 101, a touch-sensing light source 104 may have an angle of half intensity less than 40 degrees if the light-guide 101 is acrylic plate or Plexiglas, for example. In this context, an angle of half intensity is an angle at which light intensity from a light source decreases to half of its maximum emission intensity. Here, a touch-sensing light source 104 may be positioned at a certain angle relative to the edge of the light-guide plate 101.

In a particular implementation, LCD panel 102 may comprise a multilayer structure shown as FIG. 4. Two glass substrates 403 and 404 having polarizers 401 and 402 respectively adhering to one side. Red 405, green 406 and blue 407 color filter layers are fabricated on glass substrate 403. A filter allows a corresponding visible light to pass through. For example, red filter 406 allows only wavelengths of red visible light to pass through. On these color filter films is disposed on a transparent conductive layer 408 as a common electrode of LC (e.g., a common electrode that is shared by multiple pixels in an array of pixels). Pixel electrodes 409 may be insulated from one another. Pixel electrode 409 may be driven by and/or applied a voltage by a pixel TFT 410 individually. Liquid crystal layer 411 is sandwiched between a common electrode 408 and pixel electrode 409. In liquid crystal layer 411, an alignment of the liquid crystal molecules may be in accordance with a voltage applied on pixel electrode 409 to control light transmission through an associated pixel. LCD pixel driving circuit 202 may apply a suitable voltage through the pixel TFT 410 to pixel electrode 409 according to command signals from touch-sensing LCD control unit 220, for example.

Although light transmission through a pixel can be changed by tuning a voltage applied to an associated pixel electrode 409, this tunable transmission through an LCD pixel may not be suitable for infrared light with wavelength larger than 850 mn, because a polarizer may not be able to polarize electromagnetic waves larger than 850 nm. Additionally, color filters may lose their function for infrared light (e.g., infrared light can pass the color filters). It has been determined that, about 70% of infrared light with peak emission at 880 nm may pass through an LCD panel while a dark image is displayed. Here, escaped light 109 may pass through LCD panel 102 to reach backlight unit 103.

Backlight unit 103 may include backlight light source 105 to transmit visible light to illuminate an image on LCD panel 102 so that the image displayed on LCD panel 102 can be seen by the user. Backlight light source 105 can be red, green and blue LEDs, white LEDs, or fluorescent lamps, just to name a few examples. Backlight unit 103 may comprise a backlight panel including a substrate having one or more light sources attached thereto. For example, such a backlight panel may include visible light sources soldered to a PCB (not shown), and the emission light intensity may be controlled by backlight light source driving circuit 205 in accordance with signals and/or instructions from touch-sensing LCD control unit 220.

Backlight unit 103 further includes photo detectors 106 for detecting light escaped from light-guide 101. Detectors 106 may include photodiodes, phototransistors, CCD or CMOS image sensors, just to name a few examples. Detectors 106 may be further capped with filter films matched to an output of touch-sensing light source 104. Detectors 106 may be soldered to a PCB (not shown) of backlight unit 103 and can be the same PCB to which visible light sources 105 are attached.

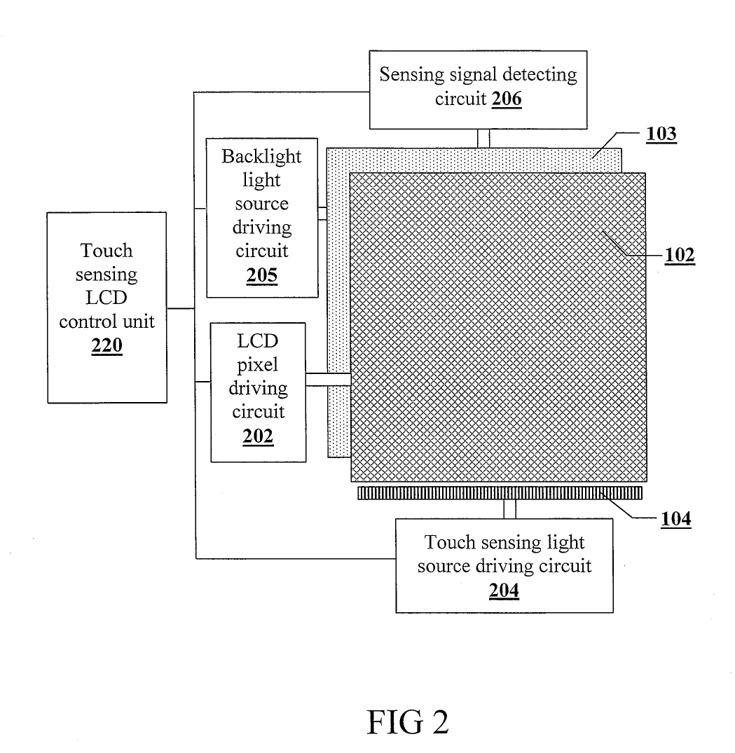

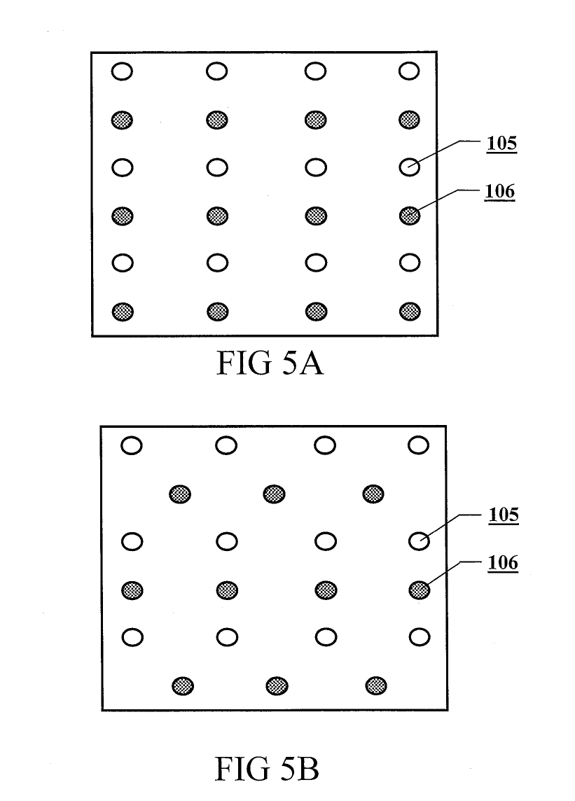

FIG. 5A and FIG. 5B are plan views of an arrangement of white LEDs light source 105 and light sensing detectors 106, according to particular embodiments. Detectors 106 may be distributed uniformly in a grid pattern among backlight light sources 105. Pitch between any two detectors 106 may be selected based on, for example, cost and touch resolution or accuracy. A small pitch may imply more detectors may be needed, incurring a higher cost. If a pitch between two detectors is too large, some detector signals may not be strong enough for accurately estimating a touch position. In one example, a pitch between two detectors is set to be close to the distance between the LCD panel and backlight plate (e.g., about 40 mm). For a touch-sensing LCD with 32 inch diagonal size, 144 detectors may be used, much fewer a number of detectors typically integrated in an LCD panel, which is typically the same as the number of LCD panel pixels. Fewer detectors may also allow the use of fewer signal processing resources. As shown in FIG. 2, a sensing light signal detecting circuit 206 may be used to receive and process signals from the photo detectors 106.

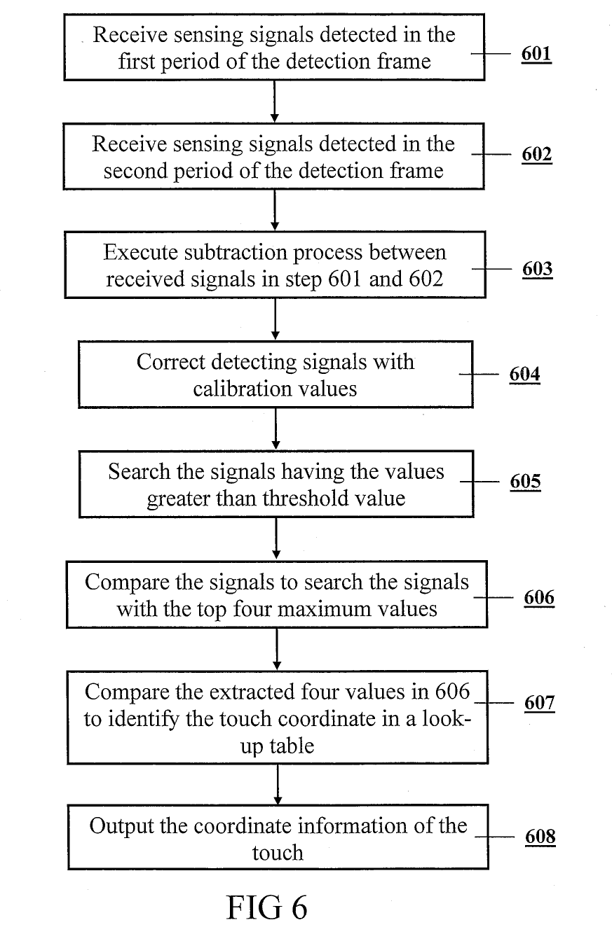

Output signals from light sensing detectors 106 may be in the form of analog signals, which may be converted to digital signals by an analog-to-digital conversion (ADC) device (not shown) which is integrated in sensing signal detecting circuit 206. These digital signals may be further analyzed by a digital signal processing circuit (not shown) which is also integrated in signal detecting circuit 206 to determine a touch object coordinate. However, other combinations of programmed processors, software and/or hardware may be used to process the digital signals. Flow chart shown in FIG. 6 illustrates how the digital signals may be processed to estimate a location of a physical touching, according to a particular embodiment.

Because the spectrum of ambient light may at least partially overlap with the spectrum of touch-sensing light, and since ambient light may vary in different environments and operating conditions, etc., ambient light may add background noise giving rise to false detections. In order to reduce such noise effects caused by ambient light, a detection frame may be divided into two periods. Here, touch-sensing light source 104 may be turned on throughout a first period and turned off throughout a second period. The digital signal processing circuit of signal sensing detecting circuit 206 may receive signals detected in the first period of the detection frame at block 601. Values associated with these signals may then be stored in a memory digital accessible by signal processing circuitry. Then, the signal processing circuitry may receive temporal subtraction signals detected in the second period of the detection frame at block 602. Block 603 may then subtract values of signals detected in the second period from values of signals detected in the second period. With the above processes, the background ambient light noise may be reduced or eliminated.

Signals extracted from subtraction at block 603 may be processed to estimate a location of a physical touching on LCD panel 102. Calibration values for light sensing detectors 106 may be based on a level of white noise and a non-uniform sensitivity for individual detectors 106, which were previously stored in a memory of digital signal processing circuitry, for example. These calibration values may be obtained by comparing signal values from detectors 106 measured in a totally dark ambient and in a uniform light illumination ambient. Values extracted from the subtraction may be mapped to and compared with calibration values to correct non-uniform response characteristics of detectors 106, such as sensitivity and white noise, at block 604. Values extracted at block 604 may be further compared with a threshold value stored previously in the digital signal processing circuit to extract the signals having values greater than the threshold value at block 605.

According to an embodiment, an intensity of a signal received at a light sensing detector 106 responsive to a physical touching on a surface of LCD panel 102 may vary as a function of a distance between the light sensing detector 106 and location of the physical touching on the surface of LCD panel 102. As such, touch sensing light detectors 106, which are laterally closer to physical touch object 107, may be expected to receive a stronger intensity light signal (e.g., light 109 escaping from optical light-guide 101) than those touch-sensing light detectors 106 at greater lateral distance away from the physical touch object 107. Accordingly, touch sensing light detectors 106 are used to detect a change in touch-sensing light (e.g., from escaping light 109) incident at a backlight panel in response to a physical touching on a surface of LCD panel 102. It should be understood, however, that this is merely one type of change in touch-sensing light (incident at a backlight panel) that may be detected according to particular embodiments, and that other types of changes such incident touch-sensing light may be detected without deviating from claimed subject matter. If light sensing detectors 106 have an arrangement as shown in FIG. 5, for example, a location or point of a physical touching is in an area bounded by four detectors 106. Here, these four detectors 106 may generate calibrated signal values that are greater than calibrated signal values generated by other detectors 106.

Unlike the photo detectors integrated in an LCD panel, where a pitch between two adjacent detectors may be only several hundred micrometers, a physical touching may be accurately located by signal values in a region. For the case of integrating detectors 106 in a backlight unit 103, as mentioned previously, in order to use fewer detectors (e.g., based on a cost consideration), a pitch between two detectors may be about ten millimeters, or even larger. In one particular implementation, to accurately estimate a location of a physical touching on LCD panel 102, an intensity of signals received by four surrounding detectors (e.g., bounding an area containing the location) may be applied to a light intensity distribution profile. Such a light intensity distribution profile may, for example, characterize a lateral distance between a location of physical touching and location of a detector 106 capturing a signal in question. In an alternative implementation, such an estimated location of a physical touching in an area bounded by detectors 106 may be selected from values in a look up table based, at least in part, on signal intensity values obtained from the detectors 106.

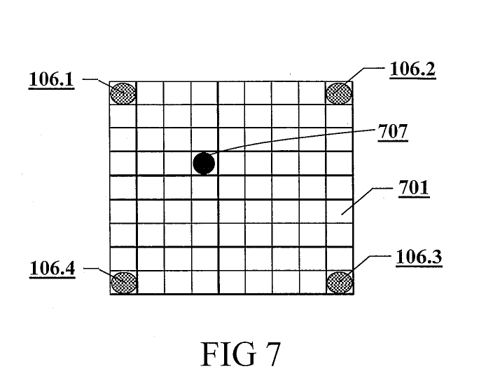

As an example, the look-up table can be configured by the following described method. Detectors in an array on the backlight plate can be divided into many blocks, each block consists of four detectors and the area surrounded by the four detectors (106.1, 106.2, 106.3 and 106.4), as shown in FIG. 7, the area is uniformly divided into many sub-areas 701. Each sub-area 701 represents a candidate touch position or location. The data stored in look-up table to identify this touch position 707 can be obtained by experimental measurement and calculation with measured results. For example, input a touch right above this position 707 on the touchable surface, the four surrounding detectors receive the intensity of the signals denoted as S₁, S₂, S₃ and S₄ respectively. The data used to identify the touch position 707 is the comparison result of these four signal values. The comparison result may be (a, b, c), where a=S₂/S₁, b=S₃/S₁ and c=S₄/S₁. The same process can be used for other touch positions to obtain a corresponding data to identify them. Then each touch position is assigned with an identification data (ID).

By comparing the extracted signals in step 606 and map their compared result with the IDs of touch position stored in look-up table, the touch position then can be identified (step 607). An identified touch position may then be sent to touch-sensing LCD control unit 220 at block 608. Control unit 220 may give a response signal and/or instruction according to the estimated location of the physical touching to update an image displayed on the LCD panel, for example.

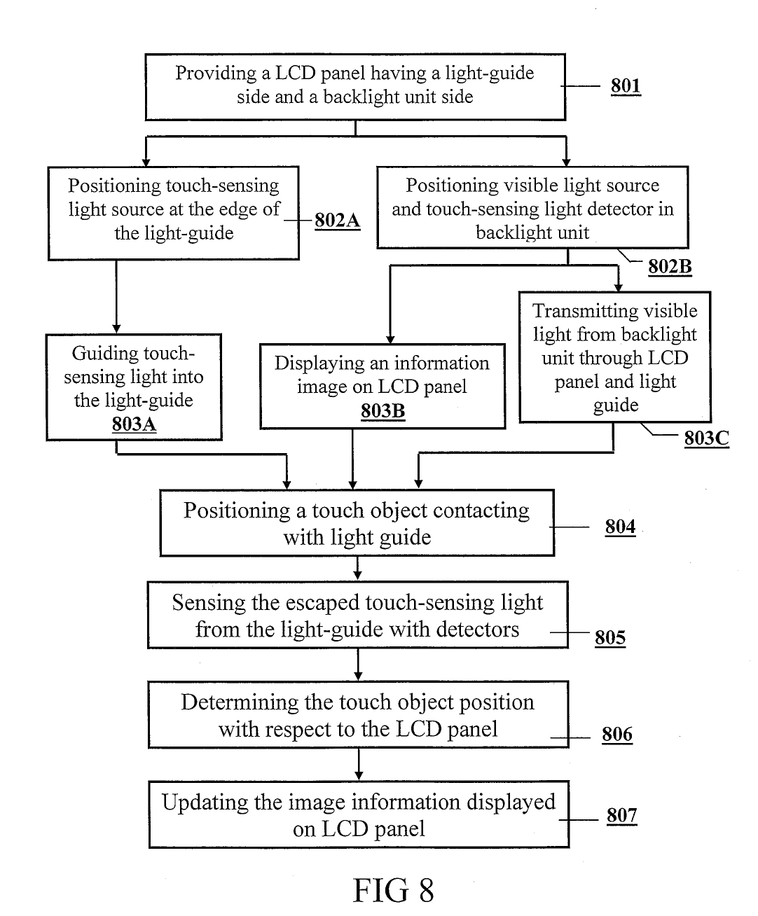

An implementation of the touch-sensing LCD 100 can be described referring to the flowchart of FIG. 8. As described previously, a touch-sensing LCD 100 comprising of LCD panel 102 with a light-guide 101 side and a backlight unit side 103 is provided at block 801. Then a touch-sensing light source 104 is positioned at an edge of the light-guide 101, a backlight light source and a touch-sensing light detector are positioned in the backlight unit (blocks 802A and 802B). Here, blocks 801, 802A and 802B illustrate a process of making a touch sensing display according to a particular implementation. During execution, control unit 220 may output image signals to the LCD pixel driving circuit 202 to change the light transmission of LCD pixels in accordance with the image signals (block 803B). At the same time, the control unit 220 may signal and/or instruct backlight driving circuit 205 to turn on the visible light sources 105 so that the image displayed on LCD panel is illuminated and can be seen by a user (block 803C). Control unit 220 may first instruct the touch-sensing light source driving circuit 204 to turn on the touch-sensing light sources 104 to guide touch-sensing light rays 110 into the light-guide 101 (block 803A). In response to a touch object 107 contacting the surface of the light-guide 101, some of the touch-sensing light may escape from the light-guide 101 by reflection or refraction (block 804). The escaped light 109 may pass through LCD panel 102 and be detected by detectors 106 located in backlight unit 103 (block 805). Sensing signal detecting circuit 206 may collect results of detection of touch-sensing light at light sensing detectors 106 and send coordinate information representing an estimated location of the touch to the control unit 220 (block 806). Then the control unit may update images displayed on LCD corresponding to the touch request (block 807).

The methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Within this disclosure, the terms “one”, “one or more”, “at least one”, are considered to be substantially equivalent. If the disclosure describes one, for example, it would be considered inherent to apply similar teaching or concept to more than one.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A touch-sensing display, comprising:
an LCD panel having a light-guide side and an LCD backlight side; and
a backlight panel comprising at least one visible light source and at least one touch-sensing light detector, the at least one visible light source arranged to transmit visible light through said LCD panel, and the at least one touch-sensing light detector disposed on said backlight to detect touch-sensing light,
wherein said at least one touch-sensing light detector is adapted to detect a change in touch-sensing light incident at said backlight panel in response to a physical touching on a surface.

2. The touch-sensing display of claim 1, and further comprising a light-guide comprising at least one touch-sensing light source disposed on at least one edge of said light-guide.

3. The touch-sensing display of claim 1, and further comprising a controller adapted to estimate a location of said physical touching on said surface of said LCD panel.

4. The touch-sensing display of claim 1, wherein said backlight panel comprises a substrate having at least one visible light source disposed thereon, and wherein said at least one touch sensing light detector is fixedly attached to said substrate.

5. The touch-sensing display of claim 4, wherein said at least one touch sensing light detector is fixedly attached to said substrate by soldering.

6. The touch-sensing display of claim 1, and further comprising a pressure transfer film disposed over a surface of said LCD panel, and wherein said at least one touch-sensing light detector is adapted to detect a change in touch-sensing light incident at said backlight panel in response to a physical touching on said pressure transfer film.

7. A method of operating a touch sensing LCD, comprising:
transmitting visible light from at least one visible light source disposed on a backlight panel through an LCD panel;
receiving one or more signals from at least one touch sensing light detector disposed on said backlight panel in response to a physical touching on a surface of said LCD panel; and
processing said received signals to estimate a location of said physical touching on said surface of said LCD panel.

8. The method of claim 7, wherein said processing said received signals further comprises calibrating values associated with said received signals based, at least in part, on signal values obtained from said at least one touch sensing light detector in a dark condition.

9. The method of claim 7, and further comprising transmitting touch-sensing light at least partially through a light-guide from at least one touch-sensing light-source in said light-guide, and wherein said received signals are representative of a change in touch-sensing light incident on said at least one touch sensing light detector.

10. The method of claim 9, wherein said change in said touch-sensing light incident on said at least one touch sensing light detector is responsive to an escape of at least a portion of touch-sensing light in said light-guide responsive to said physical touching.

11. The method of claim 7, wherein said processing said received signals further comprises:
distinguishing at least a portion of said received signals responsive to ambient light noise from a portion of said signals responsive to a change in touch-sensing light incident on said at least one touch sensing light detector.

12. The method of claim 11, wherein said touch-sensing light comprises substantially non-visible light.

13. The method of claim 11, wherein said distinguishing said portion of received signals responsive to ambient light noise from said portion of said signals responsive to said change in touch-sensing light incident on said at least one touch-sensing light detector further comprises:
receiving signals from said at least one touch-sensing light detector in a first time interval while a touch sensing light source is turned on;
receiving signals from said at least one touch-sensing light detector in a second time interval while said touch sensing light source is turned off; and
subtracting at least a portion of said signals received during said second period from at least a portion of said signals received during said first period.

14. The method of claim 7, wherein said processing said received signals to estimate said location further comprises:
determining said estimated location based, at least in part, on one or more values selected from a look-up table based, at least in part, on signal values of signals received from at least two touch-sensing light detectors.

15. The method of claim 13, and further comprising receiving signals from a plurality of touch-sensing light detectors bounding an area, and wherein said processing said received signals to estimate said location further comprises:
determining said estimated location within said bounded area based, at least in part, on one or more values selected from a look-up table based, at least in part, on signal values of signals received from said plurality of touch-sensing light detectors.

16. The method of claim 14, wherein said values stored in said look-up table are obtained based, at least in part, on calculations performed on measurements of signals of touch sensing light detectors.

17. The method of claim 14, and further comprising selecting said values from said look-up table based, at least in part, on one or more ratios of signal intensities from signals of a plurality of touch sensing light detectors bounding an area.

18. The method of claim 15, and further comprising:
determining signal values from signals received from said touch-sensing light detectors; and
selecting said plurality of touch-sensing light detectors bounding said area as providing signals having highest signal values in a region of said LCD panel.

19. The method of claim 7, and further comprising updating an image displayed on said LCD panel based, at least in part, on said estimated location of said physical touching.
